(19) United States
(12) Patent Application Publication
(10) Pub. No.: US 2006/0256428 A1
(43) Pub. Date: Nov. 16, 2006

(54) LONG WAVE PASS INFRARED FILTER BASED ON POROUS SEMICONDUCTOR MATERIAL AND THE METHOD OF MANUFACTURING THE SAME

(75) Inventors: Vladimir Kochergin, Westerville, OH (US); Mahavir Sanghavi, Columbus, OH (US); William McGovern, Hilliard, OH (US)

Correspondence Address: NIXON & VANDERHYE, PC, 901 NORTH GLEBE ROAD, 11TH FLOOR, ARLINGTON, VA, 22203, US

(73) Assignee: Lake Shore Cryotronics, Inc., Westerville, OH (US)

(21) Appl. No.: 11/383,553

(22) Filed: May 16, 2006

Related U.S. Application Data
(60) Provisional application No. 60/681,155, filed on May 16, 2005.

(51) Int. Cl. G06K 7/10

(52) U.S. Cl. 359/350; 359/358; 359/361

(57) ABSTRACT

Scattering-type long wave pass filters for the infrared region of the spectrum offer high levels of suppression of the unwanted short-wave radiation, good levels of transmission of the desired long wave radiation combined with good control of the rejection edge position and shape and good mechanical stability of the filter layer. Such filters are well suited for the wide range of applications and can be used in various environments including cryogenic temperatures. Several methods of fabrication of such filters based on electrochemical etching of semiconductor materials in order to form porous layer are provided.

### CROSS-REFERENCES TO RELATED APPLICATIONS

This application claims the benefit of U.S. Provisional Application No. 60/681,155 filed May 16, 2005, entitled “LONG WAVE PASS INFRARED FILTER BASED ON POROUS SEMICONDUCTOR MATERIAL AND THE METHOD OF MANUFACTURING THE SAME” (Attorney Docket 340-99), incorporated herein by reference.

This application is also related to commonly assigned copending application Ser. No. 10/686,520 filed 16 Oct. 2003 of Kochergin et al. entitled “SPECTRAL FILTER FOR GREEN AND LONGER WAVELENGTHS” (attorney docket 340-80)

### STATEMENT REGARDING FEDERALLY SPONSORED RESEARCH OR DEVELOPMENT

Not applicable.

### FIELD

The technology herein relates to optical filters made of porous semiconductor materials, and more specifically to scattering-type optical filters used in the infrared spectral region. Still more particularly, the technology herein relates to infrared long wave pass filters and band pass filters.

Filters of the exemplary non-limiting illustrative implementation can be used to filter light in the near infrared, mid infrared and/or far infrared spectral ranges. Advantages of porous semiconductor filters of the exemplary non-limiting illustrative implementation include improved mechanical stability, manufacturability, and a wide spectral range of transparency.

### BACKGROUND AND SUMMARY

Generally, optical filters and coatings are passive components whose basic function is to define or improve the performance of optical systems. There are many types of optical filters. They are used for a broad range of different applications. Applications of optical filters and coatings can be diverse as anti-glare computer screens, colored glass, sighting devices, and electrical spark imagers—to name just a few.

Some optical filters are specialized for different wavelength ranges of light because of limitations in available materials that are optically transparent in the range of interest. For example, many applications and instruments require optical filters that can be used to tune the optical behavior of light in the near infrared, mid infrared or far infrared wavelength range (i.e., at frequencies of radiant energy that are generally below the frequencies of visible light). Some example applications for such filters include far- and mid-IR focal-plane arrays for military applications, chemical sensing, astronomy, and space and earth observations to name a few.

Some of these applications (especially those used in mid and far IR) require filters to block the light at short wavelengths (below some “edge” wavelength) and to transmit the light over a broad range of wavelengths above the edge wavelength, while keeping the transmission in this range as high and as “flat” as possible. Such filtering is shown to significantly improve the signal-to-noise ratio of the detection system and is actively used in a large number of applications spanning from Fourier Transform Spectroscopy to astronomy and defense.

One known type of filter serving such applications is the so-called interference filter, consisting of many layers of dissimilar materials (each layer up to several micrometers thick each for far IR filters), which are commonly deposited at or above room temperature conditions. This type of filter is often strongly limited by the width of the flat portion of the transmission band. In addition, such filters can have a number of problems if used at cryogenic temperatures, a quite common environment for far IR filters serving astronomical and military applications. This is because thermal stresses during the cooling of the filters can cause layers to delaminate. This can severely limit the maximum size of the filter, its physical longevity and, through that, the performance and cost-of-use of the optical system incorporating said filters.

Another type of filter serving these applications is scattering-type filters, such as disclosed by K. R. Armstrong and F. J. Low [Appl. Optics., 13(2), p. 425, 1974]. Generally, such filters utilize a layer of diamond particles (or other transparent material) of specific sizes, spread on a surface of a sheet or substrate of a material transparent in the IR region, such as polymer materials (e.g. polyethylene), quartz or sapphire. Light with wavelengths about or below the size of the particles in the applied layer is scattered into a solid angle. If the detection means is sufficiently separated from the filter, such light is effectively blocked. On the other hand, the light with wavelengths above the size of the particles is transmitted with no or little distortion, and reaches the detector even at substantial separation. Hence, a transmission edge is created.

A schematic drawing of an exemplary such filter structure is presented in FIG. 1. In this drawing, the light-scattering particles 1.2 are disposed randomly on a transparent or other substrate 1.1. Light 1.3 with wavelengths above the characteristic size of the particle array is effectively transmitted with such a filter, while the light with wavelengths below said characteristic size 1.4 is mostly scattered into out-propagating waves 1.5. Such filters can be used both in room temperature and cryogenic applications. However, the mechanical stability of at least some such filters is usually poor since the filtering layer can be easily damaged or removed off the surface of the substrate. For example, the versions made with thin polymer films cannot withstand pressure differentials (i.e., vacuum pumping) very well.

From another point of view, porous semiconductor materials have been known for a number of years. Such materials have been proposed for use as filters, either as interference filters or as short-pass filters (see, e.g. [US patent application 20040004779 by V. Kochergin et al., filed Jun. 4, 2003], [US patent application 20050276536 by V. Kochergin et al., filed Oct. 16, 2003], [US patent application 20060027459 by M. Christophersen et al., filed May 27, 2005]).

Information about the manufacture of macroporous silicon (MPSi) arrays can be found in U.S. Pat. No. 5,262,021 issued to V. Lehmann, et al, Nov. 16, 1993 (which claims priority to Fed. Rep. Of Germany Patent # 4202454, issued Jan. 29, 1992), in which a method of the formation of free-standing macropore arrays from an n-doped Si wafer is disclosed.

Macroporous silicon layers with modulated pore diameters throughout the pore depth is disclosed in, for example, [U.S. Pat. No. 5,987,208 issued to U. Gruning and V. Lehmann et al. Nov. 16, 1999] or [J. Schilling et al., Appl. Phys. Lett. V 78, N.9, February 2001].

There are also several disclosures relating to methods of manufacturing macroporous structures with controlled positions of the pores. One such disclosure is U.S. Pat. No. 4,874,484 issued to H. Föll and V. Lehmann issued Oct. 17, 1989 (which claims priority to Fed. Rep. Of Germany Patent # 3717851 dated May 27, 1987). This patent describes a method of generating MPSi arrays from n-doped (100)-oriented silicon wafers in HF-based aqueous electrolytes (i.e., electrolytes based on HF diluted with water) under the presence of backside illumination. It also describes a method of controlling the position of macropores through formation of etch-pits. Etch pits are typically, but not exclusively, pyramid-shaped openings formed on the silicon or other semiconductor surface that can be formed through mask openings upon exposure to anisotropic chemical etchants. In addition, the use of wetting agents (such as formaldehyde) and controlling the pore profile through chronologically-varying applied electrical potentials also were disclosed.

A method of MPSi layer formation in non-aqueous electrolytes is disclosed in U.S. Pat. No. 5,348,627 issued Sep. 20, 1994 and U.S. Pat. No. 5,431,766 issued Jul. 11, 1995, both to E. K. Propst and P. A. Kohl. Organic solvent-based electrolytes were used for forming porous layers in n-doped silicon under the influence of front-side illumination. Example solvent based electrolytes are acetonitrile (MeCN), diemethyl formamide (DMF), propylene carbonate (C₃O₃H₆) and methylene chloride (CH₂Cl₂))-containing organic supporting electrolytes, such as the examples of tetrabutilammonium perchlorate (C₁₆H₃₆NClO₄), tetramethylammonium perchlorate (C₄H₁₂NClO₄) and anhydrous sources of fluoride, HF, fluoroborate (BF₄⁻), tetrabutylammonium tetrafluoroborate (TBAFB), aluminum hexafluorate (AlF₆³⁻) and hydrogen difluoride (HF₂⁻).

A method of manufacturing ordered, free-standing MPSi arrays, including pore walls coated by a semiconducting layer with follow-on oxidizing or nitriding through a CVD process was disclosed in U.S. Pat. No. 5,544,772 issued Aug. 13, 1996 to R. J. Soave, et al., in relation to the production of microchannel plate electron multipliers. N-doped silicon wafers, photoelectrochemically etched in an HF-based aqueous electrolyte, were disclosed. Another method of manufacturing MPSi-based microchannel plate electron multipliers is disclosed in U.S. Pat. No. 5,997,713 issued Dec. 7, 1999 to C. P. Beetz, et al. This patent describes an ordered, freestanding MPSi array made by the electrochemical etching of a p-doped silicon wafer. Both aqueous and non-aqueous (e.g., acetonitrile, tetrabuthylsulfoxide, propylene carbonate or metholene chloride-based) electrolytes, based on both HF and fluoride salts, were disclosed for MPSi layer manufacturing. The use of mechanical grinding, polishing, plasma etching or chemical back-thinning to remove the remaining part of the silicon wafer in line with the pores were disclosed. The use of a surfactant to improve pore quality was also taught.

The use of a conductivity-promoting agent in organic-based electrolytes (e.g., DMF) during the photoelectrochemical etching of n-doped silicon was disclosed in S. Izuo et al., Sensors and Actuators A 97-98 (2002), pp. 720-724. The use of isopropanol ((CH₃)₂CHOH) as a basis for an organic electrolyte for electrochemical etching of p-doped silicon was disclosed in, for example, A. Vyatkin et al., J. of the Electrochem. Soc., 149 (1), 2002, pp. G70-G76. The use of ethanol (C₂H₅OH) to reduce hydrogen bubble formation during electrochemical etching of silicon as an addition to aqueous HF-based electrolytes was disclosed in, for example, K. Barla et al. J. Cryst. Growth, 68, p. 721 (1984). A detailed review of the various aspects of MPSi formation can be found in H. Föll et al, Mat. Sci. Eng. R 39 (2002), pp. 93-141.

Macropores have been obtained in types of semiconductor and ceramic materials other than silicon. For example, macropores obtained in n-type GaAs by electrochemical etching in acidic electrolytes (aqueous HCl-based) were reported by, for example, D. J. Lockwood et al, Physica E, 4, p. 102 (1999) and S. Langa et al, Appl. Phys. Lett. 78(8), pp. 1074-1076, (2001) Macropores obtained in n-type GaP by electrochemical etching were reported by B. H. Erne et al., Adv. Mater., 7, p. 739 (1995). Macropore formation during the electrochemical etching of n-type InP (in aqueous and organic solutions of HCl and mixtures of HCl and H₂SO₄) was reported by P. A. Kohl et al., J. Electrochem. Soc., 130, p. 228 (1983) and more recently by Schmuki P et al., Physica Status Solidi A, 182 (1), pp. 51-61, (2000); S. Langa et al., J. Electrochem. Soc. Lett., 3 (11), p. 514, (2000). Macroporous GaN formation during electrochemical etching was reported by J. v. d. Lagemaat, Utrecht (1998). Macropore formation during electrochemical etching of Ge was reported by S. Langa et al., Phys. Stat. Sol. (A), 195 (3), R4-R6 (2003). Reviews of macropore formation in III-V semiconductors can be found in H. Föll et al., Phys. Stat. Sol. A, 197 (1), p. 64, (2003); M. Christophersen et al., Phys. Stat. Sol. A, 197 (1), p. 197, (2003), and H. Föll et al., Adv. Materials, Review, 2003, 15, pp. 183-198, (2003).

The exemplary illustrative non-limiting technology herein provides a mechanically stable infrared long-wave pass or band-pass filter utilizing the scattering in at least one layer of porous semiconductor material. The exemplary illustrative non-limiting technology herein also provides practical methods of fabricating such filters.

An exemplary illustrative non-limiting infrared filter implementation comprises a semiconductor substrate having first and second surfaces. The semiconductor material of the substrate can be silicon, germanium, III-V compound semiconductor or any other semiconductor material known to form porous semiconductor layer under the electrochemical etching process in suitable electrolyte. The array of holes (pores) is formed on a first surface of said semiconductor substrate in an infrared filter of the presently preferred exemplary non-limiting illustrative implementation such that the holes have some specific arrangement, specific distribution of sizes and specific distribution of spacings with respect to each other. Such holes form the porous layer on the first surface of the semiconductor wafer.

There can be more than one porous layer on the surface of the wafer with either different pore topology (orientation of pores with respect to each other and with respect to the surface of the wafer) or with different pore parameters (such as pore size distribution and pore spacing distribution). Said porous surface of the exemplary illustrative non-limiting semiconductor wafer in an infrared filter implementation can be coated by a layer of transparent material to serve as an antireflection layer or for the mechanical and environmental protection of the filter, or both together, or for other reasons.

The second surface of the semiconductor wafer can be left flat and uncoated to provide “flat” uniform transmission through the wide range of wavelengths across the infrared spectral region. Alternatively, said second surface of the semiconductor wafer can be coated, e.g., by one or more layers of materials that are transparent in the infrared range in order to serve as an antireflection layer. This will also enhance transmission through the exemplary illustrative non-limiting filter in the desired spectral ranges or will modify the transmission in some wavelength range through the thin film interference effect. Alternatively, said second surface of the semiconductor wafer can be geometrically structured to form an antireflection coating (similar to the “motheye” structure well-known to those skilled in the art). The nonporous portion of the semiconductor wafer can be also completely removed so the porous semiconductor membrane can be formed to act as a filter. Such a design will provide higher transmission in the pass band of the filter, but will offer less mechanical stability. Alternatively, the porous layer can be formed on the second surface of the semiconductor wafer with the same or different pore structure to enhance optical characteristics of the filter (e.g., by enhancing transmission within the pass band, sharpening the rejection edge or increasing the rejection level).

The semiconductor wafer can be bonded at the first side to another wafer that is transparent in the IR range. Fusion bonding, anodic bonding or any other type of bonding known to those skilled in the art can be used. Alternatively, said semiconductor wafer can be made of two semiconductor wafers with different doping densities bonded together before etching. The exemplary illustrative non-limiting infrared filter can be used as a long wave pass filter. Alternatively, the exemplary illustrative non-limiting filter can be used as a band pass type of filter.

### BRIEF DESCRIPTION OF THE DRAWINGS

These and other features and advantages will be better and more completely understood by referring to the following detailed description of exemplary non-limiting illustrative implementations in conjunction with the drawings of which:

FIG. 1 gives a schematic drawing of an exemplary illustrative prior art long wave pass scattering-type infrared filter;

FIG. 2 shows a schematic drawing of an exemplary illustrative non-limiting implementation of a long wave pass filter;

FIG. 3 shows a schematic drawing of an exemplary illustrative non-limiting implementation of a long wave pass filter;

FIG. 4 shows a schematic drawing of a further exemplary illustrative non-limiting implementation of a long wave pass filter;

FIG. 5 shows a schematic drawing of a further exemplary illustrative non-limiting implementation of a long wave pass filter;

FIG. 6 shows a schematic drawing of a further exemplary illustrative non-limiting implementation of a long wave pass filter;

FIG. 7 shows an exemplary plots of infrared transmission spectra through exemplary illustrative non-limiting long wave pass filters with different pore sizes and spacings;

FIG. 8 is an exemplary SEM image of the top surface of an exemplary illustrative non-limiting random macroporous silicon array;

FIG. 9 is an exemplary cross-sectional SEM image of an exemplary illustrative non-limiting macroporous silicon array with modulated pore diameters;

FIG. 10 is an exemplary cross-sectional SEM image of the macroporous silicon array etched on (111) oriented silicon wafer with pore structure; and

FIG. 11 shows an exemplary plots of the infrared transmission spectra through the long wave pass filters etched on (111)- and (100)-oriented silicon wafers).

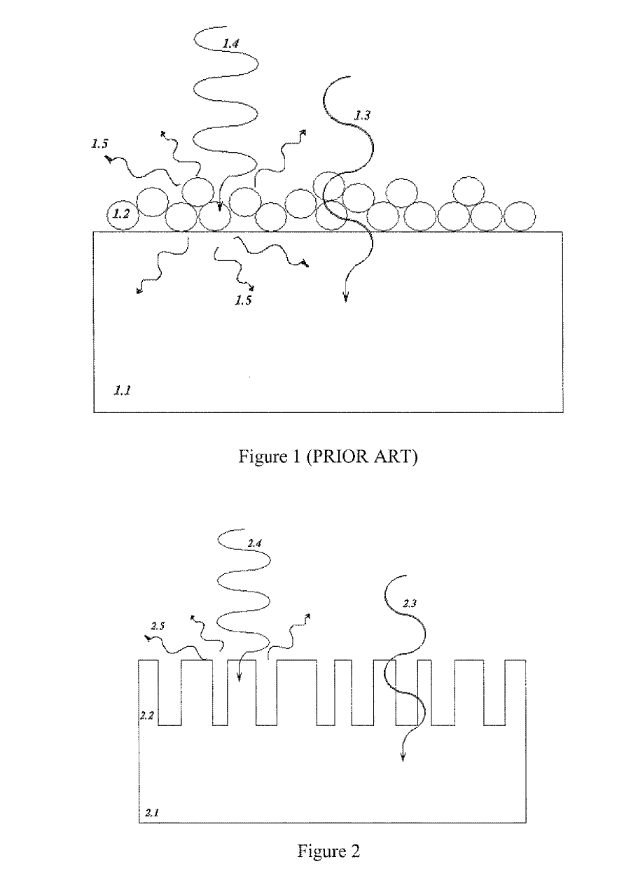

### DETAILED DESCRIPTION

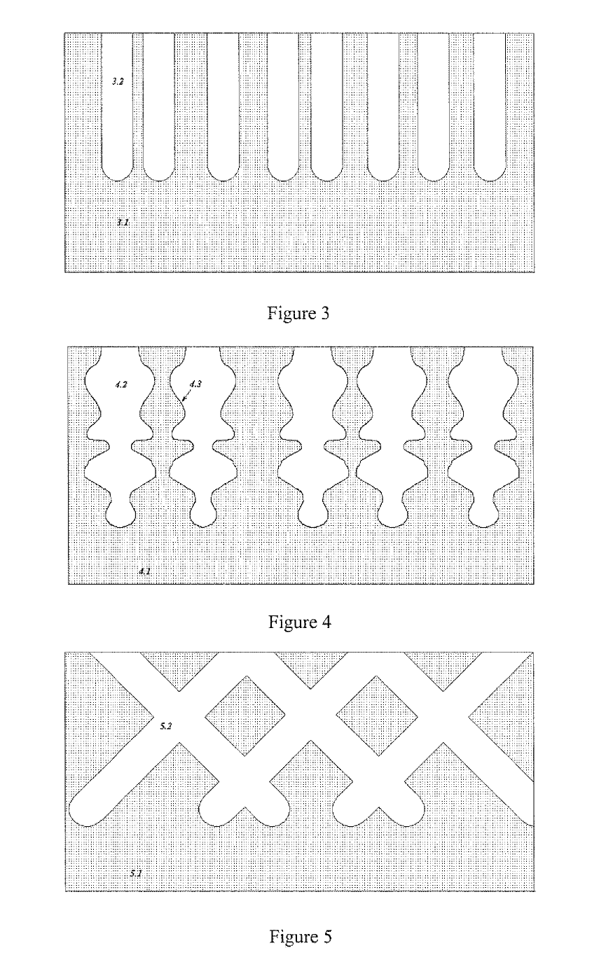

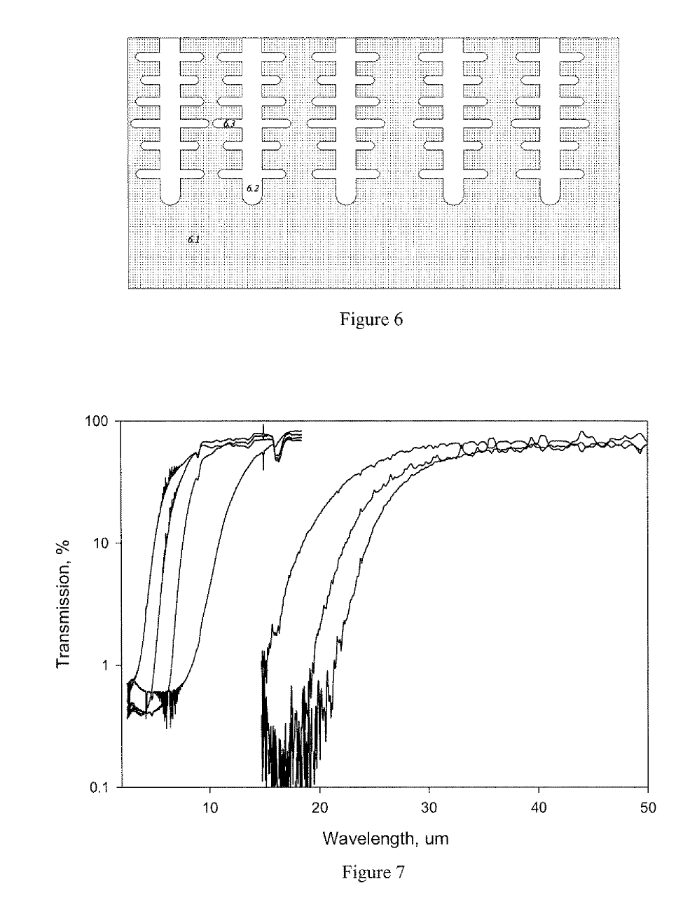

According to an exemplary non-limiting illustrative implementation, an infrared filter is made of a single-crystal semiconductor wafer having a porous layer etched at least part way through the wafer. Said pores in porous layer are essentially straight and parallel to each other such as illustrated in FIG. 3. For example, such a layer can be electrochemically etched into a silicon wafer with (100) crystallographic orientation (either n- or p-type doped) with resistivity in the range of 0.1 to 1000 Ωcm in HF-containing electrolytes with constant current (galvanostatic) or constant voltage (potentiostatic) anodic etching conditions. Alternatively, an exemplary illustrative non-limiting infrared filter can be fabricated on GaAs, GaP, InP, CaN, Ge or any other semiconductor material wafers that that are known to form the porous layer with straight and parallel pores under electrochemical etching conditions. Backside illumination can be employed during the etching process in order to generate positive minority carriers. Porous layers of this kind are obtainable on a large variety of the semiconductor materials and the dispersion of the pore-to-pore distance and pore diameters can be quite low (in some materials, such as InP, self-ordering of the pores can occur). In addition, for this geometry of the pores, the pore positions in the plane of the wafer can be controlled by preliminary structuring of the to-be-etched surface of semiconductor wafer by lithography and chemical or reactive ion etching process (formation of etch pit array). This results in a high level of control over the rejection edge spectral position and rejection edge sharpness, even in the case of a relatively shallow porous layer (with depths in the range of 5-to-20 pore diameters). However, the rejection level within the rejection band of such a filter is commonly limited to 3-4 orders of magnitude, since scattering of light mainly takes place on the first and second surfaces of a porous layer and is not significantly effective within the thickness of the porous layer due to the straightness of the pore walls.

According to a further presently preferred exemplary non-limiting illustrative implementation, the infrared filter is made of a single-crystal semiconductor wafer having a porous layer etched at least part way through the wafer. Said pores in the porous layer are essentially parallel to each other, such as illustrated in FIG. 4, but the cross-sections of the pores are modulated in the direction of the pore growth. For example, such a layer can be electrochemically etched into a silicon wafer with a (100) crystallographic orientation (either n- or p-type doped) with a resistivity in the range of 0.1 to 1000 Ωcm, in HF-containing electrolytes under variable current (galvanostatic) or variable voltage (potentiostatic) anodic etching conditions. Alternatively, an exemplary illustrative non-limiting infrared filter can be fabricated in GaAs, GaP, InP, GaN, Ge or any other semiconductor material that is known to form a porous layer with straight and parallel pores under the electrochemical etching conditions. The backside illumination can be employed during the etching process in order to generate the minority carriers. The porous layers of this kind are obtainable in a large variety of the semiconductor materials. The dispersion of the pore-to-pore distance and pore diameters can be quite low (in some materials, such as InP, self-ordering of the pores can occur). In addition, for this geometry of the pores, the pore position in the plane of the wafer can be controlled by preliminary structuring of the to-be-etched surface of semiconductor wafer by lithography and chemical or reactive ion etching processes (formation of etch pit array). This results in a high level of control over the rejection edge spectral position and rejection edge sharpness, even in the case of relatively a shallow porous layer (with depth in the range of 5-to-20 pore diameters). Due to the enhanced nonuniformity of the pore layer across its depth, the light scattering occurs not only on the first and second surfaces of the porous layer (as with the previously described exemplary filter design), but also within the thickness of the porous layer, thus providing the opportunity to increase the rejection level within the rejection band even further than 3-to-4 orders of magnitude.

According to a further exemplary illustrative non-limiting implementation, the infrared filter is made of the single-crystal semiconductor wafer having a porous layer etched at least part way tough the wafer. Said pores in the porous layer grow along a number of orientations as illustrated in FIG. 5, while the cross-sections of the pores are more or less constant along the pore length. For example, such a layer can be electrochemically etched into a silicon wafer with a (111) or (110) crystallographic orientation (either n- or p-type doped), with a resistivity in the range of 0.1 to 1000 Ωcm, in HF-containing electrolytes under a constant current (galvanostatic) or a constant voltage (potentiostatic) anodic etching condition. Alternatively, an exemplary illustrative non-limiting infrared filter can be fabricated on GaAs, GaP, InP, GaN, Ge or any other semiconductor material wafers that are known to form the porous layers with straight pores growing in a number of directions under electrochemical etching conditions. The backside illumination can be employed during the etching process in order to generate the minority carriers. The porous layers of this kind are obtainable on a large variety of semiconductor materials. Due to the morphology of the porous layer, the scattering of light is more effective across the layer depth, so the achievable rejection level within the rejection band is higher than in the filters described in the previously described exemplary illustrative non-limiting implementations at the same porous layer depth and the same distance between the detector and the filter.

In a further presently preferred exemplary non-limiting illustrative implementation, the infrared filter is made of a single-crystal semiconductor wafer having a porous layer etched at least part way through the wafer. Said pores in the porous layer can be divided into two groups according to the direction of growth: 1) main pores 6.2 which are commonly grown in a direction perpendicular to the wafer surface (i.e., in the [100] crystallographic direction) and 2) secondary pores that grow along a number of orientations, typically at some angle with respect to the direction of growth of the main pores. Such a porous layer can be electrochemically etched into an n-type doped silicon wafer with a (100) crystallographic orientation with resistivity in the range of 0.1 to 100 Ωcm, in HF-containing electrolytes under constant current (galvanostatic) or constant voltage (potentiostatic) anodic etching conditions, with no illumination or small back side illumination during the electrochemical etching process. Due to the morphology of the porous layer, the scattering of light is effective throughout the layer depth so the rejection level within the rejection band is as high as in the filters described above.

As an illustrative example, FIG. 7 shows illustrative experimental transmission spectra through several infrared filters with structures as described above. All the filters were electrochemically etched on p-doped, (100)-oriented silicon wafers with resistivity in the range of 6 Ωcm (the left curve) up to 70 Ωcm (the right curve), in HF-containing electrolytes under galvanostatic conditions. Good control over the rejection edge position, high and uniform level of the transmission within the pass band and sufficiently deep level of rejection are clearly demonstrated. The data was taken at 30 cm filter to detector separation.

FIG. 8 as an illustrative nonlimiting example shows an SEM image of a disordered porous layer surface as used in exemplary illustrative non-limiting infrared filters. The porous layer was etched on (111)-oriented p-doped silicon wafer with resistivity in the range of 10 to 30 Ωcm in a Diemethylsulfoxide/Ethanol/HF electrolyte at a galvanostatic conditions with no preliminary restructuring of the wafer surface (i.e., pores nucleated randomly on the wafer surface).

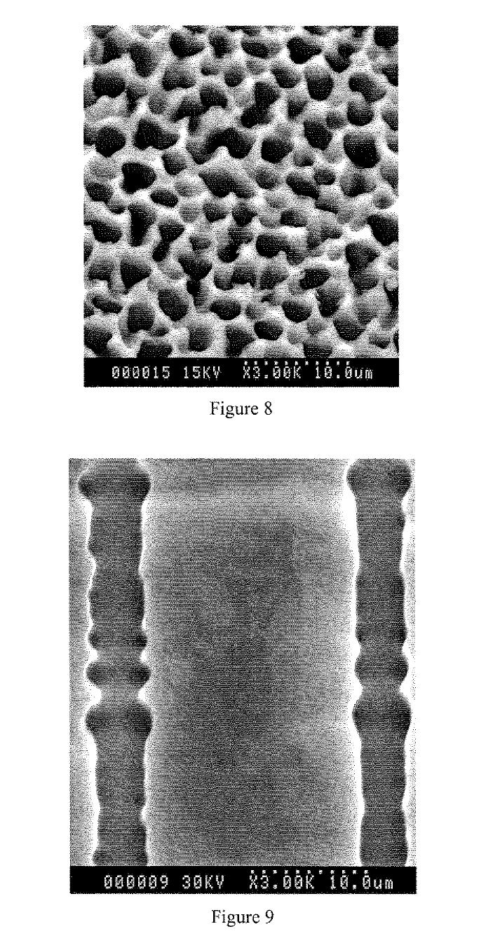

FIG. 9 is an illustrative non-limiting exemplary SEM cross-sectional image of an MPSi layer with modulated pore diameters. The wafer was (100)-oriented n-doped Si wafer with the resistivity in the range of 1-10 Ωcm etched at 4 vol. % HF aqueous electrolyte at a presence of temporally-modulated back-side illumination.

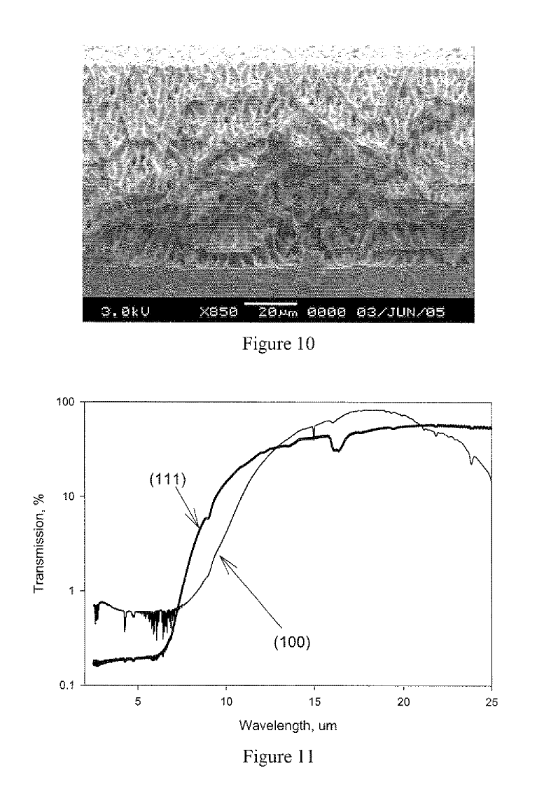

FIG. 10 is an illustrative non-limiting exemplary SEM cross-sectional image of an MPSi layer etched on (111)-oriented p-doped silicon wafer with resistivity in the range of 10 to 30 Ωcm in a Diemethylsulfoxide/Ethanol/HF electrolyte at a galvanostatic conditions with no preliminary restructuring of the wafer surface (i.e., pores nucleated randomly on the wafer surface). The strongly branching but still uniform in cross-section pores that provide effective scattering of the light at short wavelengths are clearly visible.

FIG. 11 gives an illustrative nonlimiting exemplary transmission spectra through the porous silicon long wave pass filters etched on (111) and (100) oriented p-doped wafers. Both filters had similar thickness of about 30 μm and the spacing between the filter and detector in Fourier Transform Spectrometer in both cases was about 30 cm. It is illustrated that the long wave pass filters in this exemplary illustrative non-limiting implementation show more effective scattering than that of the previously described exemplary illustrative non-limiting implementation.

The exemplary illustrative non-limiting infrared filters described herein are mechanically stable and tolerate well the pressure differentials and temperature cycling. Such filters can be used at both cryogenic temperatures and at room temperature. Optically, such filters exhibit sufficiently sharp rejection edge combined with flat and high level of transmission within the pass band, and a good and uniform rejection within the rejection band at a proper filter-to-detector separation. Such filters also show reasonably good stability at high power laser illumination and exhibit low or no polarization effect on the light transmitted within the pass band. The size of the filter is limited by the size of the semiconductor wafer, thus permitting the fabrication of filters up to 200 mm in diameter and above. The technology of fabrication of such filters is sufficiently inexpensive for filters to have competitive pricing.

While the technology herein has been described in connection with exemplary illustrative non-limiting implementations, the invention is not to be limited by the disclosure. The invention is intended to be defined by the claims and to cover all corresponding and equivalent arrangements whether or not specifically disclosed herein.

1. An infrared filter comprising:
a substrate or host silicon wafer having a first surface and a second surface and further including plural holes defined at least partially therethrough, said holes having cross-sections within a selected range of sizes, said holes being spaced by distances within a selected range, wherein said host wafer is transparent over the substantial part of the infrared spectral range; wherein light with wavelengths smaller than the characteristic size of the hole structure is effectively scattered thus forming a rejection spectral band while the light with wavelengths above said characteristic size of the pore structure is effectively transmitted through the filter thus forming a pass spectral band.

2. An infrared filter of claim 1 wherein said holes are formed on the first surface of the silicon wafer while the second surface of the silicon wafer remains flat.

3. An infrared filter of claim 1 wherein said holes are formed on both first and second surfaces of the silicon wafer.

4. An infrared filter of claim 3 wherein said holes on different surfaces of the silicon wafer have different structures thus scattering light differently.

5. An infrared filter of claim 1 wherein said holes are formed on the first surface of the silicon wafer, the second surface of the silicon wafer being covered with an antireflection structure to improve the transmission through the filter at a selected spectral band within the pass spectral band of the filter.

6. An infrared filter of claim 1 wherein at least one surface of the silicon wafer containing said holes is coated with a layer of transparent dielectric material to minimize the reflection losses at said surface of the filter.

7. An infrared filter of claim 1 wherein said holes are straight pores extending in a direction perpendicular to the surface of the silicon wafer.

8. An infrared filter of claim 7 wherein said silicon wafer is (100)-oriented silicon wafer and the holes are formed by electrochemical etching of said silicon wafer in HF-containing acidic electrolyte.

9. An infrared filter of claim 8 wherein said holes are nucleated randomly during the electrochemical etching process.

10. An infrared filter of claim 8 wherein hole etching starting points in a form of etch-pits are formed on the surface of the silicon wafer prior to the electrochemical etching by means of photolithography technique.

11. An infrared filter of claim 1 wherein said holes are pores with modulated diameters extending in a direction perpendicular to the surface of the silicon wafer.

12. An infrared filter of claim 11 wherein said silicon wafer is (100)-oriented silicon wafer, the pores are formed by electrochemical etching of said silicon wafer in HF-containing acidic electrolyte and the modulation of the pore diameter is accomplished by the modulation of the electrochemical etching parameter during the electrochemical etching process.

13. An infrared filter of claim 12 wherein said electrochemical etching parameter is selected from the group consisted of the applied current density, applied voltage and/or illumination intensity.

14. An infrared filter of claim 11 wherein said holes are nucleated randomly during the electrochemical etching process.

15. An infrared filter of claim 11 wherein hole etching starting points in a form of etch-pits are formed on the surface of the silicon wafer prior to the electrochemical etching by means of photolithography technique.

16. An infrared filter of claim 1 wherein said holes extend in a two or more directions at some angles with respect to the normal to the surface of the silicon wafer.

17. An infrared filter of claim 16 wherein said silicon wafer is (111)-oriented silicon wafer and the holes are formed by electrochemical etching of said silicon wafer in HF-containing acidic electrolyte.

18. An infrared filter of claim 17 wherein said holes are nucleated randomly during the electrochemical etching process.

19. An infrared filter of claim 1 wherein said holes are of two different types: main holes which are straight and extend in a direction perpendicular to the surface of the silicon wafer and secondary holes originating at the walls of the main holes and propagating at directions extended nearly parallel to the silicon wafer surface.

20. An infrared filter of claim 19 wherein said silicon wafer is (100)-oriented n-type doped silicon wafer and the holes are formed by electrochemical etching of said silicon wafer in HF-containing aqueous acidic electrolyte.

21. An infrared filter of claim 19 wherein said holes are nucleated randomly during the electrochemical etching process.

22. An infrared filter of claim 19 wherein hole etching starting points in a form of etch-pits are formed on the surface of the silicon wafer prior to the electrochemical etching by means of photolithography technique.

23. An infrared filter of claim 1 wherein said filter is a long wave pass filter used for scattering the short wavelength radiation and transmitting the long wave radiation light.

24. An infrared filter of claim 23 wherein said long wave pass filter is used in an optical system to increase the signal-to-noise ratio of the detector.
